(19) United States
(12) Patent Application Publication
(10) Pub. No.: US 2009/0178666 A1
(43) Pub. Date: Jul. 16, 2009

(54) OUTDOOR BAR-B-QUE GRILL WITH WIND MANAGEMENT

(75) Inventors: Larry Cagle, Bell Gardens, CA (US); Robert Evangelista, West Covina, CA (US)

Correspondence Address: IRELL & MANELLA LLP, 1800 AVENUE OF THE STARS, SUITE 900, LOS ANGELES, CA, 90067, US

(73) Assignee: Lynx Grills, Inc.

(21) Appl. No.: 12/354,143

(22) Filed: Jan. 15, 2009

Related U.S. Application Data
(60) Provisional application No. 61/011,319, filed on Jan. 15, 2008.

(51) Int. Cl. F24B 3/00; A47J 37/07

(52) U.S. Cl. 126/25 R; 126/25 A

(57) ABSTRACT

An outdoor bar-b-que grill that includes a front hood coupled to a rear hood. The front hood can be rotated to a closed position to create a chimney opening between the rear and front hoods. The grill includes a wind deflector that extends from the rear hood and is located adjacent to the chimney opening. The deflector allows air and heat to flow out of the chimney opening and impedes wind from flowing into the chimney opening.

### CROSS-REFERENCE TO RELATED APPLICATIONS

This application claims priority to Application No. 61/011,319, filed on Jan. 15, 2008.

### BACKGROUND OF THE INVENTION

1. Field of the Invention

The present invention relates to outdoor bar-b-que grills.

2. Prior Art

Large outdoor bar-b-que units typically include a cover pivotally connected to a main grill body. Within the grill body is a source of heat such as gas or charcoals. The heat source is located below grates that can support various food items. The grills are designed to include a chimney that allows heat and products of combustion to flow out of the grill. In windy conditions an oversupply of air can cause an overheating of the grill. Overheating can create safety issues and potentially damage the grill. To date, bar-b-que manufactures have addressed the wind induced overheating issue by providing instructions to not use the grill in windy conditions, or use the grill in a position that allows the wind to blow in through the grill chimney. It would be desirable to provide a bar-b-que grill unit that can be used in windy conditions while minimizing excessive heat within the grill.

### BRIEF SUMMARY OF THE INVENTION

An outdoor bar-b-que grill that includes a front hood coupled to a rear hood. The front hood can be rotated to a closed position to create a chimney opening between the rear and front hoods. The grill includes a wind deflector that extends from the rear hood and is located adjacent to the chimney opening.

### BRIEF DESCRIPTION OF THE DRAWINGS

FIG. 1 is an illustration of an outdoor bar-b-que grill;

FIG. 2 is a side view of a rear hood of the grill;

FIG. 3 is an enlarged view of a wind deflector of the rear hood; and,

FIGS. 4A and 4B are graphs showing temperatures of the grill with and without a wind deflector, respectively.

### DETAILED DESCRIPTION

Disclosed is an outdoor bar-b-que grill that includes a front hood coupled to a rear hood. The front hood can be rotated to a closed position to create a chimney opening between the rear and front hoods. The grill includes a wind deflector that extends from the rear hood and is located adjacent to the chimney opening. The deflector allows air and heat to flow out of the chimney opening and impedes wind from flowing into the chimney opening.

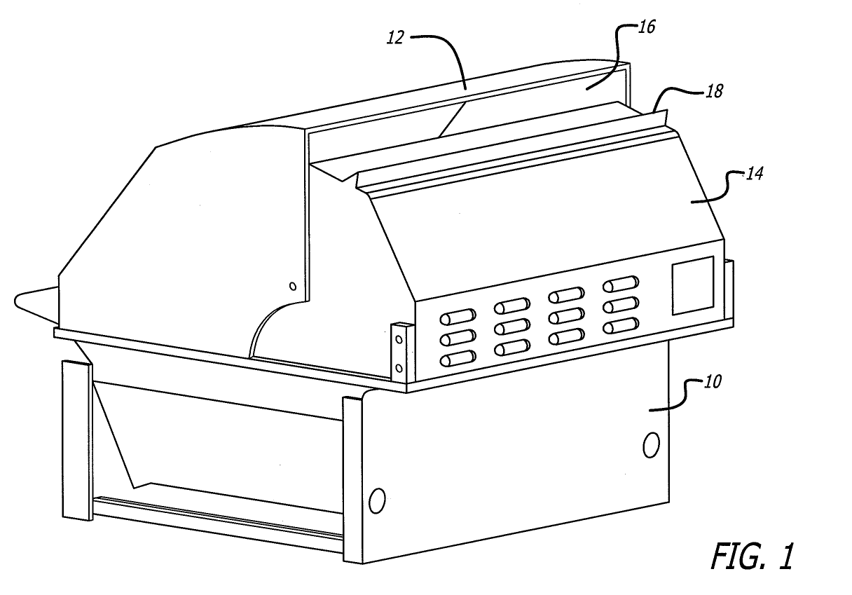

Referring to the drawings more particularly by reference numbers, FIG. 1 shows an embodiment of a bar-b-que grill 10 of the present invention. The grill 10 includes a front hood 12 pivotally connected to a rear hood 14. The grill 10 includes a heat source, grates, etc. (not shown) used to cook food items as is known in the art. The front hood 12 can be rotated to allow access to the heat source and grates. The grill 10 further includes a chimney opening 16 that allows heat and products of combustion to flow out of the grill 10 between the front hood 12 and the rear hood 14.

The rear hood 14 has a deflector 18 located adjacent to the chimney opening 16. The deflector 18 is preferably oriented at an oblique angle extending in a direction away from the opening 16. Such an orientation allows heat and products of combustion to flow out of the grill while inhibiting wind from flowing into the opening 16. The deflector 18 is located at a position relative to the chimney opening 16 to both allow heat and products of combustion to flow out of the grill and inhibit wind from flowing into the grill through the opening 16.

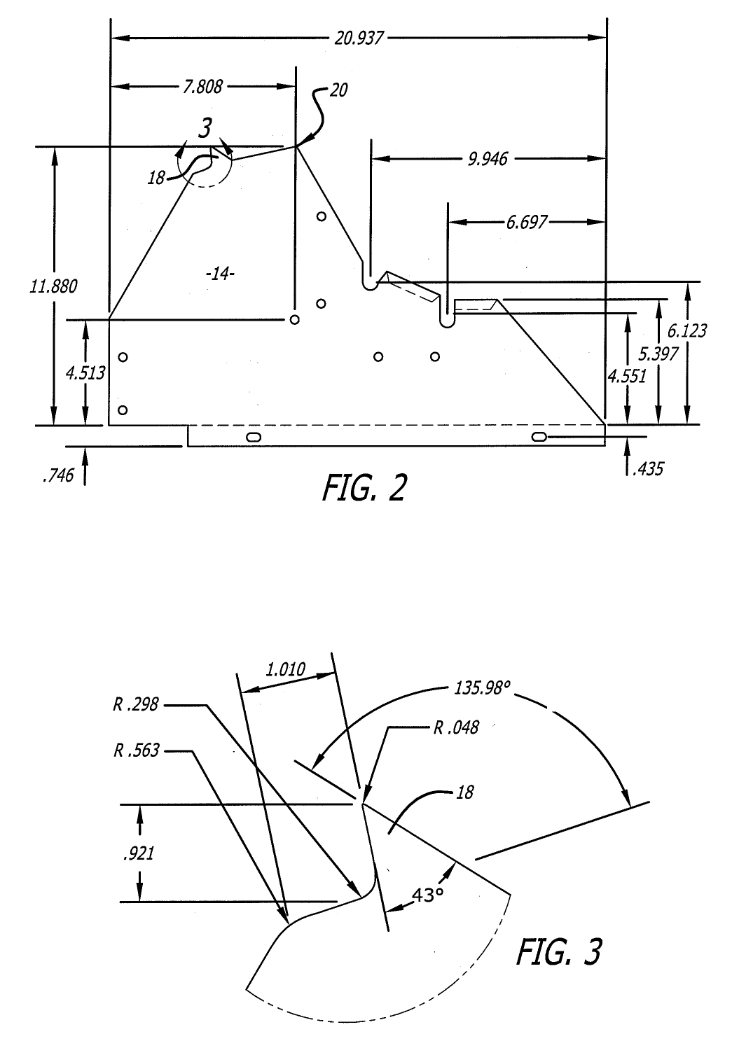

FIGS. 2 and 3 show an exemplary embodiment of a rear hood 14 and wind deflector 18. All dimensions are in inches. When the front hood (not shown) is in the closed position the rear front hood portion and opening (see FIG. 1 item 16) are roughly located at the hood apex 20. For this embodiment the height of the opening 16 is approximately 1¾ inches. The deflector 18 can be integrally formed into the rear hood 14.

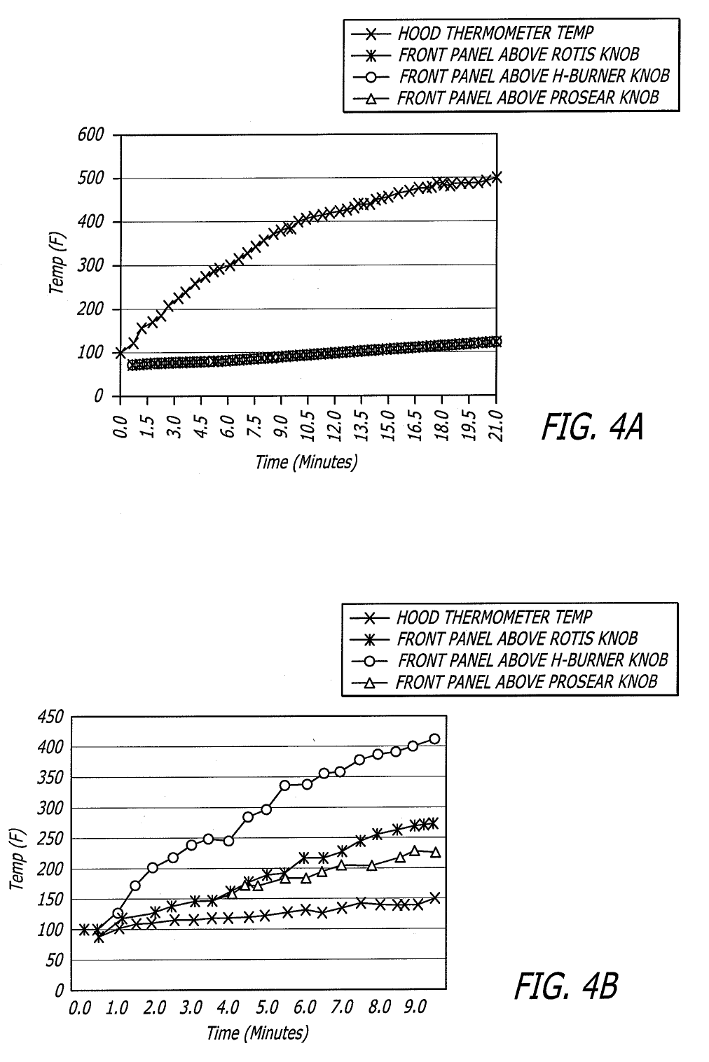

FIGS. 4A and 4B show temperature profiles of a grill with and without a deflector, respectively, operating under windy conditions. As shown in FIG. 4B, the temperature of the front grill components become elevated when there is no deflector. For example, the front knobs may become hot and create a safety issue. This is due to the wind flowing in through the chimney and blowing the heated air and products of combustion toward the front of the grill. As shown by FIG. 4A, the front grill components have a nominal increase in temperature when the grill includes a deflector of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An outdoor bar-b-que grill, comprising:
a rear hood;
a front hood coupled to said rear hood, said front hood can be rotated to a closed position to create a chimney opening between said rear hood and said front hood; and,
a wind deflector that extends from said rear hood and is located adjacent to said chimney opening.

2. The grill of claim 1, wherein said wind deflector has a profile that tapers away from said chimney opening.

3. The grill of claim 1, wherein said wind deflector is integrated into said rear hood.

4. An outdoor bar-b-que grill, comprising:
a rear hood;
a front hood coupled to said rear hood, said front hood can be rotated to a closed position to create a chimney opening between said rear hood and said front hood; and,
deflector means for allowing air and heat to flow out of said chimney opening and impeding wind from flowing into said chimney opening.

5. A method for cooking food items in an outdoor bar-b-que grill, comprising:
cooking at least one food item within an outdoor bar-b-que grill that includes a front hood coupled to a rear hood and a chimney opening between the front and rear hoods;
allowing air and heat to flow out of the chimney opening; and,
deflecting wind from flowing into the chimney opening.
